(19) United States
(12) Patent Application Publication
(10) Pub. No.: US 2004/0088703 A1
(43) Pub. Date: May 6, 2004

(54) Mechanism for implementing an interpreter with hierarchical execution loops

(76) Inventors: Nedim Fresko, San Francisco, CA (US); Nik Shaylor, Sunnyvale, CA (US)

Correspondence Address: HICKMAN PALERMO TRUONG & BECKER, LLP, 1600 WILLOW STREET, SAN JOSE, CA, 95125, US

(21) Appl. No.: 10/288,836

(22) Filed: Nov. 5, 2002

(51) Int. Cl. G06F 9/00

(52) U.S. Cl. 718/100

(57) ABSTRACT

A mechanism is disclosed for implementing an interpreter with hierarchical execution loops. In one embodiment, the interpreter has a slow processing loop and a fast processing loop. In one embodiment, the slow processing loop comprises resources for executing infrequently executed instructions and instructions with relatively complicated implementations, and the fast processing loop comprises resources for executing frequently executed instructions and instructions with relatively simple implementations. Instructions are mostly executed in the fast processing loop. Only if an instruction is not supported by the fast processing loop will it be executed in the slow processing loop. Implementing the interpreter in this manner improves cache utilization and makes it easier for a compiler to generate more optimal code for the interpreter, thereby resulting in considerably faster execution times.

### TECHNICAL FIELD

This invention relates generally to computer systems and more particularly to a mechanism for implementing an interpreter with hierarchical execution loops.

### BACKGROUND

Java source code files are compiled into intermediate instructions referred to as “bytecodes”. Once derived, these bytecodes are executed, one after the other, by a Java interpreter to implement the logic of the Java source code. Compiled Java bytecodes can be run on most computers because Java interpreters and runtime environments, referred to as Java Virtual Machines (JVM's), are available for several different operating systems. Java is a trademark of Sun Microsystems, Inc.

Typically, a Java interpreter comprises a single interpreter loop. Contained within this loop are handlers for handling each and every possible bytecode. Because there are a large number of possible bytecodes, an interpreter loop comprises a large number of handlers. As a result, an interpreter loop can be quite large.

An interpreter typically operates as follows. Initially, it obtains the first bytecode in a set of compiled bytecodes. It then looks for the handler associated with that bytecode, and invokes that handler to process, and hence, to execute that bytecode. After that bytecode is executed, the interpreter fetches the next bytecode in the program, and repeats the process. This continues until program execution is completed. Because the interpreter implements program execution by fetching an instruction, executing the instruction, and then looping back to fetch the next instruction, an interpreter is often referred to as having an interpreter loop.

It has been observed that the current interpreter loop implementation suffers from several performance problems. A first problem arises from less than optimal compilation. To elaborate, an interpreter is often written in a high level language, such as C, which needs to be compiled into machine executable code. In the compilation process, it is desirable for the compiler to assign variables that are updated frequently (e.g. the program counter and stack pointer) to registers, and to assign variables that are not updated as frequently to memory. This helps the interpreter run more efficiently when it is executed. Unfortunately, because current interpreter loops are so large and so non-optimally structured, it is difficult for a compiler to determine which variables are frequently updated and which are not. As a result, the code generated by the compiler is often less than optimal, which means that the performance of the interpreter is less than optimal.

Another performance problem arises from poor cache utilization. Because a typical interpreter loop is so large (and hence, has a large “footprint”), there is relatively low probability that information fetched into a cache for the interpreter will be reused. As a result, there are relatively few cache hits, which in turn, leads to poor cache utilization.

An interpreter loop represents a core component of a JVM. If the performance of the interpreter is poor, the performance of the JVM will also be poor. For this reason, it is important for an interpreter loop to run at maximum efficiency. As discussed above, current interpreter loops do not. Accordingly, a need exists for an improved interpreter implementation.

### SUMMARY

According to one embodiment of the present invention, there is provided a mechanism for implementing an interpreter with multiple hierarchical interpreter loops. More specifically, in one embodiment, an interpreter comprises a fast processing loop and a slow processing loop. The fast processing loop comprises resources for processing and executing simple bytecodes and bytecodes that are executed most frequently. The slow processing loop comprises resources for processing and executing complicated bytecodes and bytecodes that are executed infrequently. Each loop comprises functionality for jumping to the other loop.

The hierarchy between the two loops is a preference hierarchy. That is, it is preferable for most of the bytecode processing to take place in the fast processing loop. Only if a bytecode cannot be processed in the fast processing loop will it be deferred to the slow processing loop.

Implementing the interpreter in this manner overcomes the shortcomings of the current interpreter loop implementation. Specifically, by separating the interpreter into two loops, thereby giving the interpreter more structure, it is more likely that a compiler will be able to accurately determine which variables to assign to registers and which variables to assign to memory. Thus, the compiler will be more likely to generate more optimal code. Also, by separating the interpreter into two loops, thereby making the footprint of each loop smaller, it is more likely that when each loop is executed, the information fetched into cache will be reused. As a result, cache utilization is improved. These and other benefits may be derived from the present invention.

### BRIEF DESCRIPTION OF THE DRAWINGS

The systems and methods described herein are illustrated by way of example, and not by way of limitation, in the figures of the accompanying drawings. Similar reference numbers are used throughout the drawings to reference similar elements and features.

FIG. 1 illustrates a flow diagram of a procedure for creating an interpreter having two separate portions.

FIG. 2 illustrates a flow diagram of a procedure for executing bytecodes using an interpreter having two separate loops.

FIG. 3 is a block diagram that illustrates an exemplary computer system upon which the procedures discussed herein may be implemented.

### DETAILED DESCRIPTION OF EMBODIMENT(S)

The mechanism described herein executes multiple instructions using multiple interpreter loops. For purposes of explanation, numerous specific details are set forth in order to provide a thorough understanding of the mechanism. It will be apparent, however, that the mechanism described herein may be implemented without these specific details. The specification and drawings are, therefore, to be regarded in an illustrative rather than a restrictive sense.

Particular examples discussed herein use the Java™ programming environment developed by Sun Microsystems, Inc. and the C programming language. However, the mechanism described herein can be used with a variety of different programming environments and/or programming languages. Particular embodiments of the mechanism discussed herein can be implemented with any high-level language that is capable of being compiled into a machine-readable language.

As discussed above, an interpreter is a program that executes instructions that have been compiled into an intermediate form. A specific type of interpreter, a Java interpreter, executes Java bytecodes. The terms “instruction” and “bytecode” are used interchangeably in the sample embodiment discussed below.

The following pseudo code represents a typical single-loop interpreter.

InterpretMethod ( ):

pc = methodStart ( );
bytecode = *pc;
goto (handler_for (bytecode));

handlers:

op1:

execute (op1);
dispatch_next ( );

op2:

execute (op2);
dispatch_next ( );

. . .
op_n:

execute (op_n);
dispatch_next ( );

This traditional type of interpreter may experience one or more of the problems discussed in the Background section above.

To improve the performance of the interpreter and to overcome one or more of the problems discussed above, a multiple loop interpreter is provided. In one embodiment, to give rise to a multiple loop interpreter, “fast” bytecodes are separated from “slow” bytecodes. In one embodiment, fast bytecodes include: (1) bytecodes that have simple implementations; and (2) bytecodes that are executed frequently. Slow bytecodes include: (1) bytecodes that have complicated implementations; and (2) bytecodes that are executed infrequently. Examples of slow bytecodes include:

Bytecodes that resolve symbolic references and are rewritten into “quick” versions. Examples include bytecodes to access static and instance fields, and bytecodes to invoke methods for the first time at a specific call site.

Bytecodes that have been determined to be executed infrequently due to dynamic profiles of applications. Examples include bytecodes for multi-dimensional array allocation, and conversions between double-precision floating point values and integers.

After partitioning the bytecodes into fast bytecodes and slow bytecodes, an interpreter is generated that includes two separate loops. The following pseudo code represents such an interpreter comprising a “slow” loop and a “fast” loop. The slow loop comprises resources or handlers for processing the slow bytecodes, while the fast loop comprises resources for processing the fast bytecodes.

SlowInterpret:

pc = methodStart ( );
bytecode = *pc;
goto (handler_for (bytecode));

slow_handlers:

// Execute the slow case bytecodes here
op-s1:

execute (op-s1);
dispatch_next ( );

op-s2:

execute (op-s2);
dispatch_next ( );

. . .
op-sn:

execute (op-sn);
dispatch_next ( );

// Jump to FastInterpret for any of the fast bytecodes
op-f1:
op-f2:
op-f3:
. . .
op-fm:

FastInterpret (pc);
dispatch_next ( );

Fast Interpret:

pc = methodStart ( );
bytecode = *pc;
goto (handler_for (bytecode));

fast_handlers:

// Execute the fast case bytecodes here
op-f1:

execute (op-f1);
dispatch_next ( );

op-f2:

execute (op-f2);
dispatch_next ( );

. . .
op-fm:

execute (op-fm);
dispatch_next ( );

// Jump to SlowInterpret if a slow bytecode is encountered
op-s1:
op-s2:
op-s3:
. . .
op-sn:

SlowInterpret (pc);
dispatch_next ( );

Each interpreter loop also comprises logic for jumping to the other loop. Thus, if a loop does not comprise the resource needed to process a particular bytecode, then it jumps to the other loop and enables that other loop to process the bytecode. This will be explained in further detail in a later section.

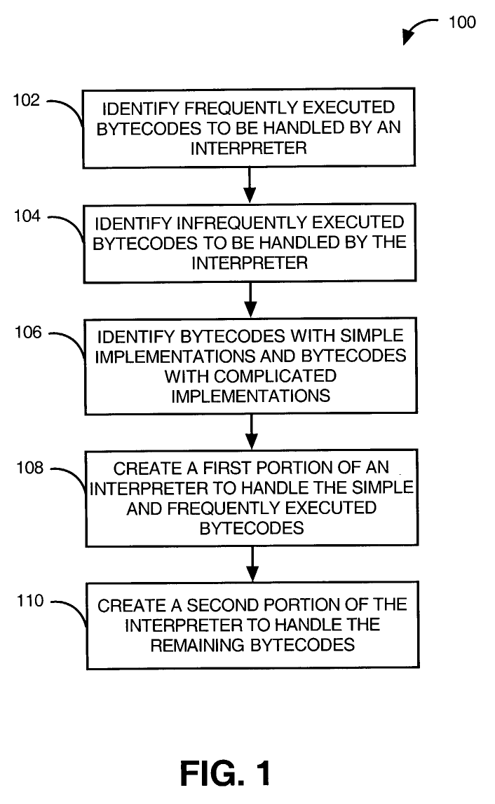

FIG. 1 illustrates a flow diagram of a procedure 100 for creating an interpreter having two separate portions. Procedure 100 may be implemented by a human developer, or by a code generator, which automatically generates computer code to implement the functionality of the interpreter. The generated code may be in the C programming language, or in any other desired language. The procedure begins by identifying frequently executed bytecodes to be handled by an interpreter (block 102). These frequently executed bytecodes can be identified, for example, by analyzing the bytecodes to be executed by the interpreter. Analyzing the bytecodes may include predicting the number of times a particular bytecode is executed for a particular operation or when operating on a particular set of data. For example, an analysis of the bytecodes may identify 40 instances of an “ADD” bytecode but only two instances of a “MULTIPLY” bytecode. In this example, the ADD bytecode is considered a frequently executed bytecode and the MULTIPLY bytecode is considered an infrequently executed bytecode. Alternatively, the interpreter may begin processing bytecodes using a benchmark data set to identify frequently executed bytecodes. In this situation, the benchmark data set is representative of data expected to be handled by the interpreter during normal operation.

The procedure continues by identifying infrequently executed bytecodes to be handled by the interpreter (block 104). The identification of infrequently executed bytecodes can be accomplished using procedures similar to those discussed above with respect to identifying frequently executed bytecodes. Procedure 100 then identifies bytecodes that have relatively simple implementations, and bytecodes that have relatively complicated implementations (block 106). Example bytecodes that are complicated and/or time-consuming to implement include bytecodes that resolve symbolic references and are rewritten into “quick” versions, and bytecodes that test for class initialization. These complicated and/or time-consuming bytecodes can be identified based on knowledge of the operation of various bytecodes.

The procedure 100 continues by creating a first portion of an interpreter to handle the frequently executed bytecodes and the bytecodes with relatively simple implementations (block 108). Among other things, this entails inserting into the first portion a handler for each frequently executed bytecode and each bytecode with a simple implementation. This first portion of the interpreter is referred to as a “fast loop”. At block 10, the procedure 100 creates a second portion of the interpreter to handle the remaining bytecodes (e.g., the complicated bytecodes and the infrequently executed bytecodes). Among other things, this entails inserting into the second portion a handler for each infrequently executed bytecode and each bytecode with a complicated implementation. This second portion of the interpreter is referred to as a “slow loop”. In addition to the handlers, the procedure 100 also inserts into each loop some logic for jumping to the other loop. In one embodiment, the fast loop has logic for jumping to the slow loop, and the slow loop has logic for jumping to the fast loop. That way, if a loop does not have the resource (e.g. the handler) to process a particular bytecode, it can jump to the other loop to process that particular bytecode. In one embodiment, the bytecodes that are processed by the fast loop and the bytecodes that are processed by the slow loop are mutually exclusive. That is, there is no overlap of bytecodes between the loops. Hence, a bytecode will be processed by one and only one of the loops. In alternative embodiments, there may be some overlap of bytecodes between the two loops, if such an overlap is desired.

By creating a slow loop and a fast loop, this embodiment of the present invention in effect creates a hierarchy of interpreter loops. This hierarchy is a preference hierarchy. That is, it is preferable for most of the bytecode processing to take place in the fast processing loop. Only if a bytecode cannot be processed in the fast processing loop will it be deferred to the slow processing loop. Once the two portions of the interpreter are created, the interpreter can be compiled and then executed to interpret bytecodes.

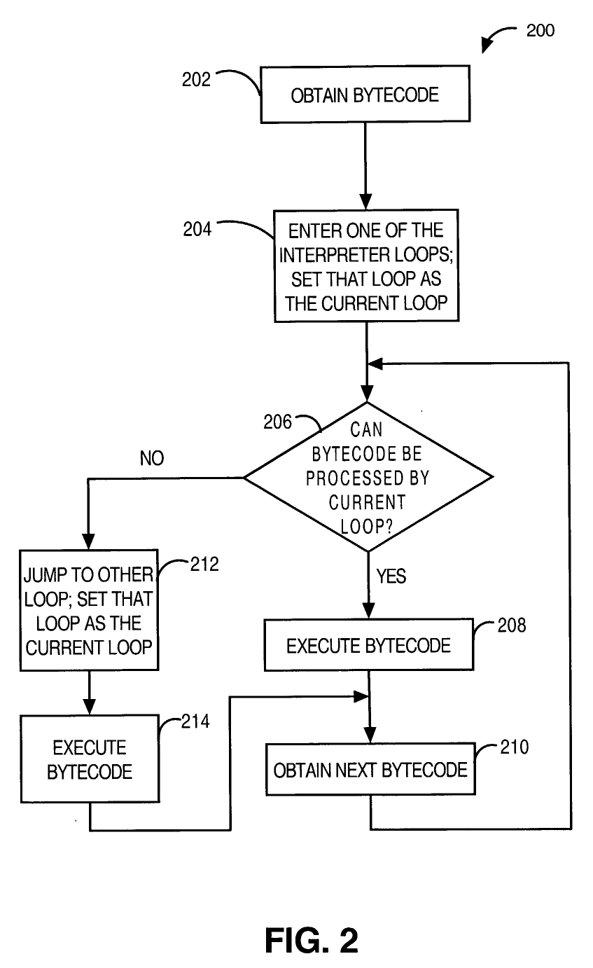

FIG. 2 illustrates a flow diagram of a procedure 200 for executing bytecodes using an interpreter having two separate loops. The procedure 200 begins by obtaining or fetching a bytecode from a set of bytecodes (block 202). This set of bytecodes may, for example, represent a compiled version of a Java program. After the bytecode is obtained, one of the loops of the interpreter is entered (block 204), and that loop is set as the “current” loop. For purposes of the present invention, it does not matter which loop (the fast loop or the slow loop) is initially entered. It is more important that once a loop is entered, processing stays within that loop, as will be explained further below. For purposes of illustration, it will be assumed that the fast loop is the one that is initially entered.

Once a loop is entered and is set as the current loop, it is determined whether the current loop has the resources to process or execute the fetched bytecode (block 206). For example, it is determined whether the current loop has the handler associated with the fetched bytecode. If so, then the fetched bytecode is executed by the current loop (block 208). Thereafter, the next bytecode is obtained (block 210) and the procedure loops back to block 206.

On the other hand, if the current loop does not have the resources to execute the fetched bytecode, then a jump is made to the other loop (block 212), and that loop is set as the current loop. Thereafter, the fetched bytecode is executed (block 214) by the other loop (which is now the current loop). The next bytecode is then obtained (block 210), and the procedure loops back to block 206. Bytecodes are thus executed by the two interpreter loops.

Recall from previous discussion that the first portion of the interpreter (the fast loop) is created to process the simple bytecodes and the most frequently executed bytecodes. Because it processes the most frequently executed bytecodes, the fast loop will process most of the bytecodes in a set of bytecodes. Thus, once the fast loop becomes the current loop, it will most likely stay the current loop. Unless a complicated bytecode or an infrequently executed bytecode is encountered, the procedure will not jump to the slow loop. Even if a jump is made to the slow loop, it is likely that the procedure will soon thereafter jump back to the fast loop. As a result, most of the bytecode processing will be carried out in the fast loop. Because of this, and because the fast loop has a relatively small footprint (compared to an interpreter loop that has handlers for all possible bytecodes), information fetched into a cache during bytecode execution has a greater likelihood of being reused. Consequently, cache utilization is improved.

Also, because the interpreter is separated into two loops, thereby giving it more structure, it is more likely that a compiler, when compiling the interpreter, will be able to determine accurately which variables to assign to registers and which variables to assign to memory. As a result, the compiler will be more likely to generate more optimal code. Overall, the interpreter of this embodiment of the present invention represents a significant improvement over the single-loop interpreters that are currently used.

Thus far, the invention has been described with reference to an interpreter having two loops. It should be noted, though, that the concepts taught herein may be applied to implement an interpreter having any n number of loops where n is an integer greater than 1. This and other variations are within the scope of the present invention.

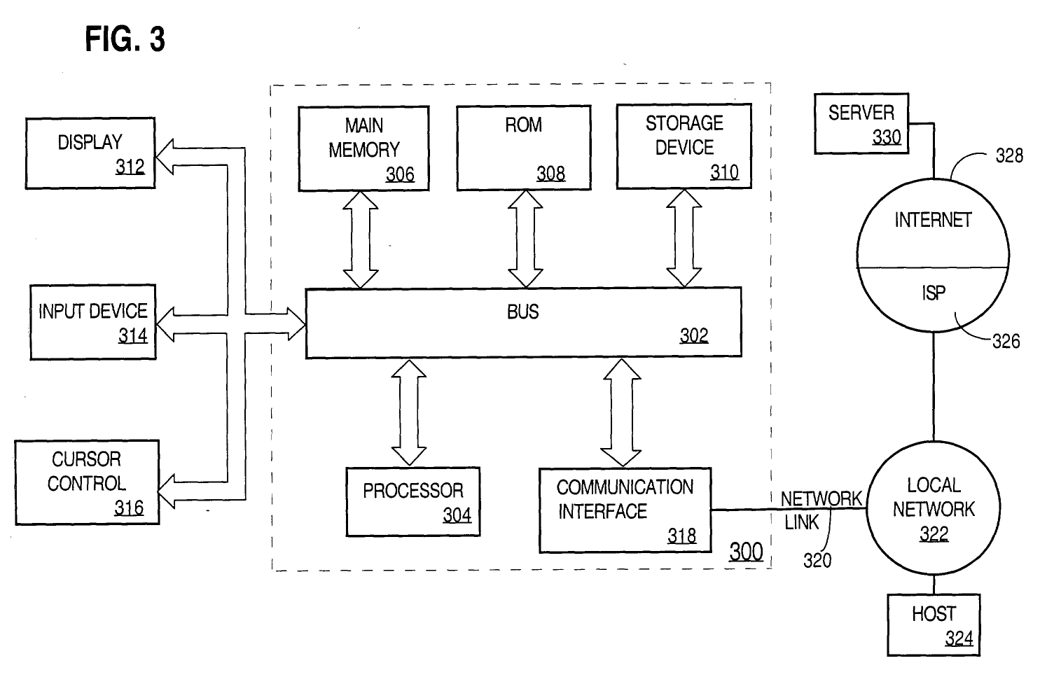

FIG. 3 is a block diagram that illustrates a computer system 300 upon which the procedures discussed herein may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

According to one embodiment of the present invention, the code generator and the interpreter described above may be implemented as one or more sequences of instructions that are executable by processor 304. Such instructions may reside in main memory 306, or may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the systems and methods described herein. Thus, the described systems and methods are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 304 for execution. For example, the instructions may initially be carried on a magnetic disk of a remote computer. The remote computer can load the instructions into its dynamic memory and send the instructions,over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution. In this manner, computer system 300 may obtain application code in the form of a carrier wave.

At this point, it should be noted that although the invention has been described with reference to a specific embodiment, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the appended claims.

What is claimed is:

1. An interpreter for executing instructions, comprising:
a plurality of portions, each portion being separate from other portions, each portion comprising resources for executing a particular subset of instructions, and each portion comprising functionality for jumping to another portion when an instruction to be executed is not part of the particular subset of instructions that that portion has resources to execute.

2. The interpreter of claim 1, wherein the interpreter is a Java bytecode interpreter.

3. The interpreter of claim 1, wherein the interpreter comprises a first portion comprising resources for executing a first subset of instructions, and a second portion comprising resources for executing a second subset of instructions.

4. The interpreter of claim 3, wherein said first portion comprises a first interpreter loop, and said second portion comprises a second interpreter loop.

5. The interpreter of claim 4, wherein said first subset of instructions comprises frequently executed instructions, and wherein said second subset of instructions comprises infrequently executed instructions.

6. The interpreter of claim 4, wherein said first subset of instructions comprises instructions with relatively simple implementations, and wherein said second subset of instructions comprises instructions with relatively complicated implementations.

7. The interpreter of claim 4, wherein said first subset of instructions comprises frequently executed instructions and instructions with relatively simple implementations, and wherein said second subset of instructions comprises infrequently executed instructions and instructions with relatively complicated implementations.

8. The interpreter of claim 4, wherein said first subset of instructions and said second subset of instructions are mutually exclusive.

9. A computer implemented method for executing instructions, comprising:
obtaining an instruction to be executed;
determining whether the instruction can be executed by a first portion of an interpreter, wherein the first portion of the interpreter comprises resources for executing a first subset of instructions;
in response to a determination that the instruction cannot be executed by the first portion of the interpreter, jumping to a second portion of the interpreter, wherein the second portion of the interpreter comprises resources for executing a second subset of instructions; and
invoking one or more resources in the second portion of the interpreter to execute the instruction.

10. The method of claim 9, further comprising:
in response to a determination that the instruction can be executed by the first portion of the interpreter, invoking one or more resources in the first portion of the interpreter to execute the instruction.

11. The method of claim 10, wherein the first and second portions of the interpreter are separate portions.

12. The method of claim 11, wherein the first subset of instructions and the second subset of instructions are mutually exclusive.

13. The method of claim 11, wherein the first portion of the interpreter comprises a first interpreter loop, and the second portion of the interpreter comprises a second interpreter loop.

14. The method of claim 13, wherein the first subset of instructions comprises frequently executed instructions, and wherein the second subset of instructions comprises infrequently executed instructions.

15. The method of claim 13, wherein the first subset of instructions comprises instructions with relatively simple implementations, and wherein the second subset of instructions comprises instructions with relatively complicated implementations.

16. The method of claim 13, wherein the first subset of instructions comprises frequently executed instructions and instructions with relatively simple implementations, and wherein the second subset of instructions comprises infrequently executed instructions and instructions with relatively complicated implementations.

17. The method of claim 9, further comprising:
obtaining a second instruction to be executed;
determining whether the second instruction can be executed by the second portion of the interpreter;
in response to a determination that the second instruction cannot be executed by the second portion of the interpreter, jumping to the first portion of the interpreter; and
invoking one or more resources in the first portion of the interpreter to execute the second instruction.

18. The method of claim 17, further comprising:
in response to a determination that the second instruction can be executed by the second portion of the interpreter, invoking one or more resources in the second portion of the interpreter to execute the second instruction.

19. The method of claim 9, wherein the instruction is a Java bytecode, and wherein the interpreter is a Java bytecode interpreter.

20. A method for creating an interpreter, comprising:
identifying a first subset of instructions to be executed by an interpreter;
identifying a second subset of instructions to be executed by the interpreter;
generating a first portion of the interpreter, said first portion comprising resources for executing the first subset of instructions, said first portion further comprising functionality for jumping to another portion of the interpreter if said first portion cannot execute an instruction encountered by said first portion; and
generating a second portion of the interpreter separate from said first portion, said second portion comprising resources for executing the second subset of instructions, said second portion further comprising functionality for jumping to another portion of the interpreter if said second portion cannot execute an instruction encountered by said second portion.

21. The method of claim 20, wherein said first portion comprises functionality for jumping to said second portion if said first portion cannot execute an instruction encountered by said first portion, and wherein said second portion comprises functionality for jumping to said first portion if said second portion cannot execute an instruction encountered by said second portion.

22. The method of claim 20, wherein the first subset of instructions and the second subset of instructions are mutually exclusive.

23. The method of claim 20, wherein said first portion of the interpreter comprises a first interpreter loop, and wherein said second portion of the interpreter comprises a second interpreter loop.

24. The method of claim 23, wherein the first subset of instructions comprises frequently executed instructions, and wherein the second subset of instructions comprises infrequently executed instructions.

25. The method of claim 23, wherein the first subset of instructions comprises instructions with relatively simple implementations, and wherein the second subset of instructions comprises instructions with relatively complicated implementations.

26. The method of claim 23, wherein the first subset of instructions comprises frequently executed instructions and instructions with relatively simple implementations, and wherein the second subset of instructions comprises infrequently executed instructions and instructions with relatively complicated implementations.

27. The method of claim 20, wherein the first subset of instructions and the second subset of instructions are subsets of an overall set of Java bytecodes.

28. A computer readable medium, comprising:
computer code for causing one or more processors to obtain an instruction to be executed;
computer code for causing one or more processors to determine whether the instruction can be executed by a first portion of an interpreter, wherein the first portion of the interpreter comprises resources for executing a first subset of instructions;
computer code for causing one or more processors to jump, in response to a determination that the instruction cannot be executed by the first portion of the interpreter, to a second portion of the interpreter, wherein the second portion of the interpreter comprises resources for executing a second subset of instructions; and
computer code for causing one or more processors to invoke one or more resources in the second portion of the interpreter to execute the instruction.

29. The computer readable medium of claim 28, further comprising:
computer code for causing one or more processors to invoke, in response to a determination that the instruction can be executed by the first portion of the interpreter, one or more resources in the first portion of the interpreter to execute the instruction.

30. The computer readable medium of claim 29, wherein the first and second portions of the interpreter are separate portions.

31. The computer readable medium of claim 30, wherein the first subset of instructions and the second subset of instructions are mutually exclusive.

32. The computer readable medium of claim 30, wherein the first portion of the interpreter comprises a first interpreter loop, and the second portion of the interpreter comprises a second interpreter loop.

33. The computer readable medium of claim 32, wherein the first subset of instructions comprises frequently executed instructions, and wherein the second subset of instructions comprises infrequently executed instructions.

34. The computer readable medium of claim 32, wherein the first subset of instructions comprises instructions with relatively simple implementations, and wherein the second subset of instructions comprises instructions with relatively complicated implementations.

35. The computer readable medium of claim 32, wherein the first subset of instructions comprises frequently executed instructions and instructions with relatively simple implementations, and wherein the second subset of instructions comprises infrequently executed instructions and instructions with relatively complicated implementations.

36. The computer readable medium of claim 28, further comprising:
computer code for causing one or more processors to obtain a second instruction to be executed;
computer code for causing one or more processors to determine whether the second instruction can be executed by the second portion of the interpreter;
computer code for causing one or more processors to jump, in response to a determination that the second instruction cannot be executed by the second portion of the interpreter, to the first portion of the interpreter; and
computer code for causing one or more processors to invoke one or more resources in the first portion of the interpreter to execute the second instruction.

37. The computer readable medium of claim 36, further comprising:
computer code for causing one or more processors to invoke, in response to a determination that the second instruction can be executed by the second portion of the interpreter, one or more resources in the second portion of the interpreter to execute the second instruction.

38. The computer readable medium of claim 28, wherein the instruction is a Java bytecode, and wherein the interpreter is a Java bytecode interpreter.

39. A computer readable medium, comprising:
computer code for causing one or more processors to identify a first subset of instructions to be executed by an interpreter;
computer code for causing one or more processors to identify a second subset of instructions to be executed by the interpreter;
computer code for causing one or more processors to generate a first portion of the interpreter, said first portion comprising resources for executing the first subset of instructions, said first portion further comprising functionality for jumping to another portion of the interpreter if said first portion cannot execute an instruction encountered by said first portion; and
computer code for causing one or more processors to generate a second portion of the interpreter separate from said first portion, said second portion comprising resources for executing the second subset of instructions, said second portion further comprising functionality for jumping to another portion of the interpreter if said second portion cannot execute an instruction encountered by said second portion.

40. The computer readable medium of claim 39, wherein said first portion comprises functionality for jumping to said second portion if said first portion cannot execute an instruction encountered by said first portion, and wherein said second portion comprises functionality for jumping to said first portion if said second portion cannot execute an instruction encountered by said second portion.

41. The computer readable medium of claim 39, wherein the first subset of instructions and the second subset of instructions are mutually exclusive.

42. The computer readable medium of claim 39, wherein said first portion of the interpreter comprises a first interpreter loop, and wherein said second portion of the interpreter comprises a second interpreter loop.

43. The computer readable medium of claim 42, wherein the first subset of instructions comprises frequently executed instructions, and wherein the second subset of instructions comprises infrequently executed instructions.

44. The computer readable medium of claim 42, wherein the first subset of instructions comprises instructions with relatively simple implementations, and wherein the second subset of instructions comprises instructions with relatively complicated implementations.

45. The computer readable medium of claim 42, wherein the first subset of instructions comprises frequently executed instructions and instructions with relatively simple implementations, and wherein the second subset of instructions comprises infrequently executed instructions and instructions with relatively complicated implementations.

46. The computer readable medium of claim 39, wherein the first subset of instructions and the second subset of instructions are subsets of an overall set of Java bytecodes.
